(19) United States
(12) Patent Application Publication
(10) Pub. No.: US 2017/0239750 A1
(43) Pub. Date: Aug. 24, 2017

(54) LASER WELDING METAL WORKPIECES

(71) Applicant: GM GLOBAL TECHNOLOGY OPERATIONS LLC, DETROIT, MI (US)

(72) Inventors: David S. Yang, Shanghai (CN); Justin A. Wolsker, Shelby Township, MI (US); Bradley J. Blaski, Sterling Heights, MI (US); Jeff Wang, Jiangsu (CN); Jing Zhang, Shanghai (CN); Wu Tao, Shanghai (CN)

(21) Appl. No.: 15/506,113

(22) PCT Filed: Aug. 25, 2014
(86) PCT No.: PCT/US14/52455

§ 371 Date: Feb. 23, 2017

(51) Int. Cl. B23K 26/244; B23K 26/10; B23K 26/16

(52) U.S. Cl. CPC B23K 26/244; B23K 26/16; B23K 26/10; B23K 2201/18

(57) ABSTRACT

A method of laser welding a workpiece stack-up includes directing a laser beam at a top surface of a first metal workpiece to form a key-hole that entirely penetrates the workpiece stack-up, including an underlying second metal workpiece, so that the keyhole reaches a bottom surface of the second metal workpiece. A zone of negative pressure established under the bottom surface of the second metal workpiece extracts vapors that are produced by the laser beam. The vapors, in particular, are extracted from the bottom surface of the second metal workpiece through the keyhole. A bottom workpiece holder that supports the bottom metal workpiece during laser welding may be constructed to establish the zone of negative pressure.

### TECHNICAL FIELD

The technical field of this disclosure relates generally to laser welding and, more particularly, to laser welding of metal workpieces that may include materials that vaporize at laser welding temperatures.

### BACKGROUND

Laser welding is a metal joining process in which a laser beam is directed at a metal workpiece stack-up to provide a concentrated heat source capable of effectuating a weld joint between the workpieces. In general, two or more metal workpieces are first aligned and stacked relative to one another so that their faying surfaces overlap and confront at an intended welding region. A laser is then targeted against one side of the workpiece stack-up and conveyed along a weld path. The heat generated from the absorption of laser energy creates a keyhole that penetrates through the metal workpiece impinged by the laser and at least partially through the underlying metal workpiece(s). Heat from the keyhole initiates lateral melting of the metal workpieces to establish a surrounding molten weld pool in both workpieces that, when cooled, results in a metallurgical joint between the workpieces.

The automotive industry frequently uses laser welding to join metal sub-assemblies into a finished part that can be installed on a vehicle. In one example, a vehicle door body may be fabricated from an inner door panel and an outer door panel that are joined together around their peripheries by a plurality of laser welds. To assist the laser welding process, the inner and outer door panels may securely clamped and held together by a series of workpiece holders that are positioned around the workpieces in predetermined locations. The workpiece holders help keep the overlapping metal workpieces closely-coupled and in alignment so that the laser welds can be formed with minimal disruption. After the workpiece holders are engaged, a moveable laser head intermittently directs a laser beam at multiple sites around the stacked panels, while conveying the laser along a weld path at each site, in accordance with a programmed sequence to form the plurality of laser welds. The process of laser welding inner and outer door panels (as well as other vehicle part components such as those used to fabricate hoods, trunk lids, etc.) is typically an automated process that can be carried out quickly and efficiently.

The use of laser welding in conjunction with certain types of metal workpieces can present some challenges. In particular, various types of defects can occur—such as spatter and porosity—in the laser weld joint when the bulk material of one or both of the metal workpieces, or any of the metal workpiece surfaces, include materials that are vaporizable at the temperatures generated by the laser beam. For example, galvanized steel includes a thin coating of zinc for corrosion protection. Zinc has a boiling point of about 906° C. while the melting point of the base steel it coats is typically greater than 1300° C. Thus, when laser welding zinc-coated steel workpieces, a high pressure zinc vapor is readily produced. This zinc vapor, in turn, can permeate the molten weld pool produced by the laser, leading to weld discrepancies that have the effect of degrading the mechanical properties of the ultimately-formed weld joint. Similar weld joint impairments may also arise when laser welding workpiece stack-ups that include one or more copper or aluminum alloys workpieces, as the surfaces of those types of workpieces often include residual vaporizable lubricants from die-forming or other upstream processing operations.

The vaporization of materials during laser welding has the tendency to be most disruptive when the faying surfaces of the metal workpieces are tightly-fit with a zero-gap surface-to-surface abutment at the weld site. Such a workpiece stack-up configuration has an increased potential to result in a non-conforming laser weld joint since the vaporized material, having no other avenue of escape, diffuses into and through the molten weld pool. For this reason, metal workpieces that include (or may include) volatile surface materials, such as galvanized steel workpieces, are oftentimes scored with a laser beam to create spaced apart protruding features on one or both of the workpiece faying surfaces before laser welding takes place. The protruding features impose a gap of about 0.1-0.2 millimeters between the workpiece faying surfaces when the metal workpieces are stacked up and clamped in preparation for laser welding. This gap provides an escape path away from the weld site for any materials that vaporize during laser welding and, thus, promotes weld joint strength and integrity. But the formation of protruding workpiece surface features adds an additional step (i.e., forming the protruding features) to the overall laser welding process and tends to produce undercut welds that, while acceptable, are not as desirable as laser welds that are formed between abutting workpiece surfaces that do not have an intentionally imposed gap to facilitate vapor escape.

### SUMMARY OF THE DISCLOSURE

A system and method of laser welding a workpiece stack-up that includes two or three overlapping metal workpieces is disclosed in which at least one of the metal workpieces includes a material that is vaporizable at laser welding temperatures. For example, the metal workpieces in the stack-up may be galvanized steel workpieces, which include zinc coatings on one or both of their surfaces for corrosion protection. As another example, the metal workpieces in the stack-up may be aluminum alloy workpieces, such as an aluminum-magnesium-silicon alloy, or copper or copper alloy workpieces. Metal workpieces composed of aluminum alloy, copper, or copper alloy often include residual lubricants on one or both of their surface from die-forming operations. These die-forming lubricants present challenges similar to those presented by zinc in that the heat generated by the laser beam during laser welding is sufficient to vaporize the lubricants.

When the two or three metal workpieces of the workpiece stack-up are assembled in overlapping fashion, the workpiece stack-up includes at least a first metal workpiece and a second metal workpieces. The first metal workpiece has a top surface and the second metal workpiece has a bottom surface. And every workpiece faying interface between the top and bottom surfaces of the first and second metal workpieces, respectively, is a zero-gap interface at a laser weld site. For example, in one embodiment, each of the first and second metal workpieces of the workpiece stack-up may include a faying surface, and those two faying surfaces confront and abut one another to provide a single zero-gap faying interface. In another embodiment, the workpiece stack-up may include an additional third metal workpiece situated between the first and second metal workpieces at the weld site. Here, the faying surfaces of the first and second metal workpieces confront and abut opposed surfaces of the interposed third metal workpiece to provide two zero-gap faying interfaces. The disclosed method involves laser welding such workpiece stack-ups having a zero-gap faying interface or interfaces despite the fact that a vaporizable material is present in the stack-up.

The method involves directing a laser beam at a top surface of the first metal workpiece such that the laser beam forms a keyhole that traverses the faying interface(s) of the metal workpieces and entirely penetrates the workpiece stack-up, including the second metal workpiece, to reach a bottom surface of the second metal workpiece. A zone of negative pressure established underneath the second metal workpiece is then able to extract any vaporized materials (e.g., zinc vapors, residual lubricant vapors, etc.) that are produced through the keyhole. The negative pressure zone may be established by a workpiece holder situated against the bottom surface of the second metal workpiece. The workpiece holder may, for example, include a channel located underneath the weld path that the keyhole tracks during laser welding. A flow of fluid may be passed through the channel at a suitable velocity, or a vacuum device may evacuate air from the channel, to establish a negative pressure within the channel and to carry vaporized material away from the workpiece stack-up.

The laser welding method employed here is preferably practiced in conjunction with remote laser welding apparatus in which a scanning optic laser head focuses and directs a laser beam at a top surface of the first metal workpiece at a focal length that typically ranges from about 0.4 meters to about 1.5 meters. A shielding gas is generally not dispensed along the weld path tracked by the laser beam, but it can be if desired. In addition to remote laser welding, it should be appreciated that the laser welding method described here can also be practiced with a conventional laser welding apparatus in which a laser beam is passed through a focusing lens and emitted from a shield gas nozzle along with an inert shielding gas. The focal length of the laser beam, which is measured from the proximal tip of the shield gas nozzle, ranges from about 150 mm to about 250 mm, which is much shorter than the focal lengths that accompany remote laser welding.

### BRIEF DESCRIPTION OF THE DRAWINGS

FIG. 1 is a partial perspective view of an embodiment of a laser welding apparatus for forming laser welds in a workpiece stack-up that includes two overlapping metal workpieces;

FIG. 2 is a partial cross-sectional view of two metal workpieces and a portion of one embodiment of a workpiece holder used to assist in forming a laser weld; and

FIG. 3 is a partial cross-sectional view of two metal workpieces and a portion of another embodiment of a workpiece holder used to assist in forming a laser weld.

### DETAILED DESCRIPTION

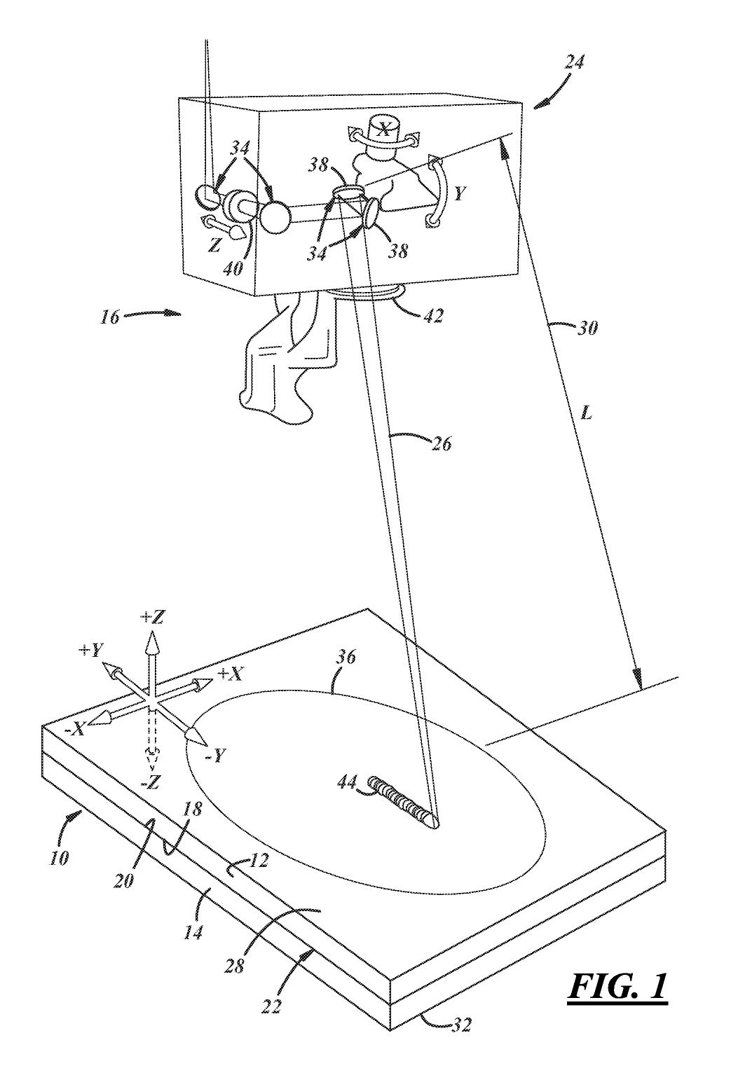

A system and method of laser welding a workpiece stack-up 10 that includes a first galvanized steel workpiece 12 and a second galvanized steel workpiece 14 with a laser welding apparatus 16 are shown in FIGS. 1-3. A faying surface 18 of the first galvanized steel workpiece 12 and a faying surface 20 of the second galvanized steel workpiece 14 overlap and make contact to provide a faying interface 22 at the weld site. Such overlapping contact between the faying surfaces 18, 20 is defined by a zero-gap interface; that is, the faying surfaces 18, 20 abut one another and are not separated by purposefully induced gaps or spaces (like the imposed 0.1-0.2 mm gap that has previously been employed) in excess of industry-accepted manufacturing tolerances.

FIGS. 1-3 are thus directed to the embodiment in which the workpiece stack-up 10 includes two overlapping metal workpieces having a single faying interface. Of course, as previously indicated, the workpiece stack-up 10 may also include three overlapping metal workpieces that provide two faying interfaces, despite not being explicitly shown in the Figures. Skilled artisans will nonetheless know how to adapt the following detailed practice of the disclosed method without much difficulty to make it amenable to laser welding a workpiece stack-up that includes three metal workpieces. And while the system and method described in FIGS. 1-3 are directed to galvanized steel workpieces, it should be appreciated that other metal workpieces, such as copper and copper alloy and aluminum alloy workpieces, may also be laser welded in a similar way since those metals may include surface lubricants and/or contaminants that, like zinc, will vaporize at temperatures below the melting point of their respective base metals.

As shown in FIG. 1, the laser welding apparatus 16 may be a remote laser welding apparatus (also sometimes referred to in the industry as “welding on the fly”) that includes a scanning optic laser head 24. The scanning optic laser head 24 focuses and directs a laser beam 26—typically a solid-state laser beam—towards a top surface 28 of the first galvanized steel workpiece 12 and is preferably mounted to a robotic arm (not shown) that quickly and accurately carries the laser head 24 to all the different weld sites on the workpiece stack-up 10. The laser beam 26 is maintained at a focal length 30 of about 0.4 meters to about 1.5 meters above the top surface 28 of the first galvanized steel workpiece 12 and, for the most part, has a focal point between the top surface 28 of the first galvanized steel workpiece 12 and a bottom surface 32 of the second galvanized steel workpiece 14 during welding,

The scanning optic laser head 24 includes an arrangement of deflector devices 34 that maneuver the laser beam 26 within a three-dimensional process envelope 36. The arrangement of the deflector devices 34 includes a pair of tiltable scanning mirrors 38 that can move the laser beam 26 in the x-y plane of the operating envelope 36 by coordinating their movements. And a z-axis focal lens 40 can change the focal point of the laser beam 26 in the z-direction. All of these components 38, 40 can be rapidly indexed in a matter of milliseconds to focus and direct the laser beam 26 precisely as intended at the workpiece stack-up 10 to form a laser weld joint 44 (shown from the top in FIG. 1) with a particular profile shape and penetration depth between the first and second galvanized steel workpieces 12, 14. A cover slide 42, moreover, may be situated below the laser head 24 to keep dirt and debris from adversely affecting the optical system. Many kinds of commercially available scanning optic laser heads may be used with the remote laser welding apparatus including, for example, a PFO (programmable focusing optic) from Trumpf (headquartered in Ditzingen, Germany).

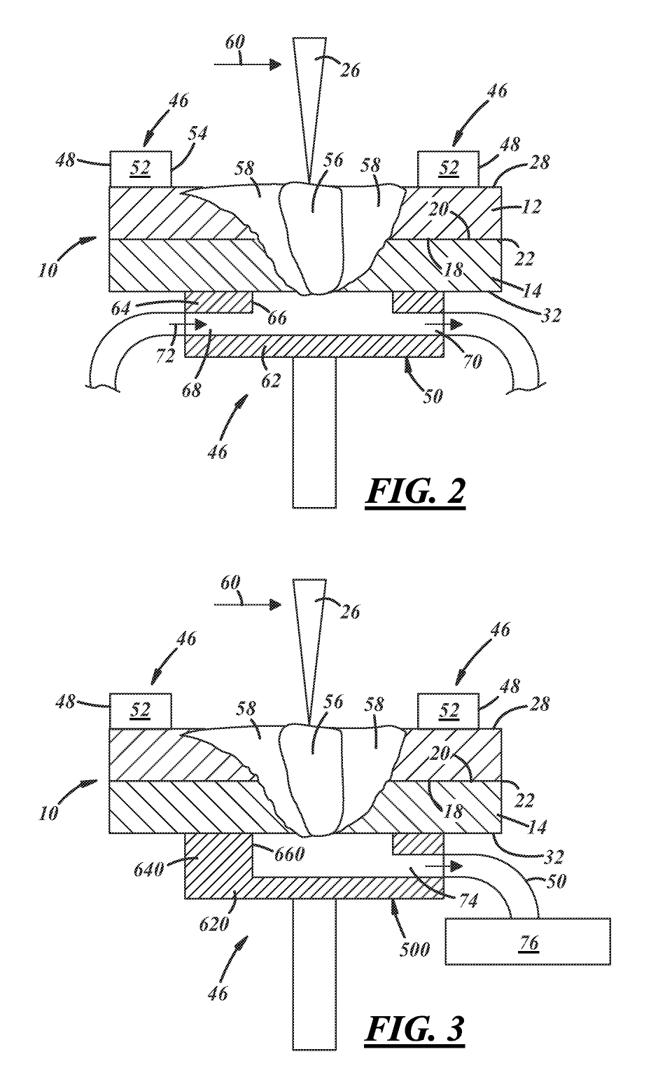

The first and second galvanized steel workpieces 12, 14 can be laser welded with a zero-gap interface between their faying surfaces 18, 20 by implementing techniques capable of extracting vaporized zinc from the bottom surface 32 of the second galvanized workpiece 14. As shown in FIGS. 2 and 3, for example, the vaporized zinc is extracted from the bottom surface 32 of the second galvanized workpiece 14 through the keyhole by establishing a zone of negative pressure (relative to atmospheric pressure) underneath the weld site. By extracting the vaporized zinc through the keyhole, and in particular through the keyhole from the bottom surface 32 of the second galvanized steel workpiece 14, the vaporized zinc is effectively removed from the welding site in a way that does not contaminate the molten weld pool produced by the laser beam 26. The laser weld joint 44 that ultimately forms when the molten weld pool solidifies is not only mechanically sturdy and acceptably strong, but it is obtainable without having to practice the additional step of scoring protruding features into one or both of the faying surfaces 18, 20 in order introduce a gap between the galvanized steel workpieces 12, 14.

FIG. 2 depicts one embodiment of a technique for establishing a zone of negative pressure to extract zinc vapor. There, a partial cross-sectional view of the workpiece stack-up 10 is shown at a weld site where the laser welding apparatus 16 (not illustrated here) is forming a laser weld. The first and second galvanized steel workpieces 12, 14 overlap, as previously indicated, to provide a faying interface 22 where the confronting faying surfaces 18, 20 of the workpieces 12, 14 are brought together and realize a zero-gap abutment at the weld site. A plurality of workpiece holders 46 clamps the first and second galvanized steel workpieces 12, 14 together to maintain the faying interface 22 at the weld site while the laser beam 26 is directed by the scanning optic laser head 24 towards the top surface 28 of the first galvanized steel workpiece 12. The workpiece holders 46 include one or more top workpiece holders 48 that engage and press against the top surface 28 of the first galvanized steel workpiece 12 and a bottom workpiece holder 50 that engages and presses against the bottom surface 32 of the second galvanized steel workpiece 14. The top and bottom workpiece holders 48, 50 may be actuated in any suitable manner such as, for example, a pneumatic or hydraulic fashion.

The top workpiece holder(s) 48 may be constructed in any functional way. For example, each of the one or more top workpiece holders 48 may have a U-shaped body that includes elongated mechanical fingers 52, two of which (one from each of two adjacent top workpiece holders 48) are depicted in FIG. 2. The elongated mechanical fingers 52, as shown, are pressed against the top surface 28 of the first galvanized steel workpiece 12 and are separated by a space 54 that is large enough to accommodate the full intended weld path of the laser beam 26 at the weld site. The bottom workpiece holder 50 may also be constructed in any suitable fashion so long as it has the capability to establish a zone of negative pressure underneath the bottom surface 32 of the second galvanized steel workpiece 14 at the weld site. An exemplary construction of the bottom workpiece holder 50 as illustrated in FIG. 2 along with its particular mode of operation will be described in more detail below.

During operation of the laser welding apparatus 16, the laser beam 26 impinges the top surface 28 of the first galvanized steel workpiece 12 and attains a focal point between the top surface 28 of the first galvanized steel workpiece 12 and the bottom surface 32 of the second galvanized steel workpiece 14. The intensity and focal point of the laser beam 26 are adapted to create a keyhole 56 in the immediate surrounding vicinity of the laser beam 26 that fully penetrates the workpiece stack up 10. In other words, the keyhole 56 extends from the top surface 28 of the first galvanized steel workpiece 12 all the way to the bottom surface 32 of the second galvanized steel workpiece 14. The keyhole 56, which is a column of vapor and plasma derived from absorption of the focused energy of the laser beam 26, induces outward lateral melting of the galvanized steel workpieces 12, 14 to produce a molten weld pool 58. As the keyhole 56 moves along a weld path, which in FIG. 2 is from left to right as shown by arrow 60, the molten weld pool 58 follows, leaving behind a wake of molten material derived from each galvanized steel workpiece 12, 14 that eventually cools and solidifies into the weld joint 44.

The bottom workpiece holder 50 is constructed with the dual-functionality of pressing against the bottom surface 32 of the second galvanized steel workpiece 14 to help hold the workpieces 12, 14 together at the weld site, and, additionally, to extract vaporized zinc from the bottom surface 32 through the keyhole 56. As shown in FIG. 2, the bottom workpiece holder 50 may have a body 62 that includes an upstanding rim 64. The upstanding rim 64 is the portion of the body 62 that contacts the bottom surface 32 of the second galvanized steel workpiece 14 when operationally engaged. It also defines a channel 66. This channel 66 is sized and shaped so that it encompasses the entire area of the bottom surface 32 of the second galvanized steel workpiece 14 through which the keyhole 56 will penetrate during movement of the laser beam 26 along its weld path. A fluid inlet 68 and a fluid outlet 70 communicate with the channel 66 to allow a flow 72 of fluid to pass through the channel 66 during laser welding. The fluid that passes through the channel 66 may be an inert gas, such as argon or helium, or it may be a liquid, such as water. A gas permeable layer, such as a membrane or perforated substrate, may cover the cavity 66, especially if the fluid is a liquid, to limit or entirely preclude exposure the bottom surface 32 of the second galvanized steel workpiece 14 the fluid flow 72.

The fluid is introduced through the fluid inlet 68 and out of the fluid outlet 70 at a velocity that creates a negative pressure within the channel 66 and beneath the bottom surface 32 of the second galvanized steel workpiece 14. Thus, when the laser beam 26 is tracking its weld path, any zinc vapors that are created at the surfaces 18, 20, 28, 32 of the workpieces 12, 14 are drawn into the keyhole 56. And because the keyhole 56 entirely penetrates the second galvanized steel workpiece 14, the negative pressure zone created in the channel 66 siphons zinc vapors through the keyhole 56 and out of the bottom surface 32 of the second galvanized steel workpiece 14. The siphoned-off zinc vapors are then removed from the channel 66 and carried away by the flow 72 of fluid through the fluid outlet 70. By providing the zinc vapors with an avenue escape through the keyhole 56, the first and second galvanized steel workpieces 12, 14 can be laser welded together along their zero-gap faying interface 22 without accumulating an unacceptable amount of discrepancies in the weld joint 44.

FIG. 3 depicts another way to construct the bottom workpiece holder, designated here with reference numeral 500, to have the dual-functionality described above. Here, like before, the workpiece holder 500 has a body 620 that includes an upstanding rim 640. The upstanding rim 640 contacts the bottom surface 32 of the second galvanized steel workpiece 14 and also defines a channel 660 in the same way as in FIG. 2. The channel 660, again, is sized and shaped so that it encompasses the entire area of the bottom surface 32 of the second galvanized steel workpiece 14 through which the keyhole 56 will penetrate during movement of the laser beam 26 along its weld path. One difference in the workpiece holder 500 shown in FIG. 3, as compared to FIG. 2, is that a vacuum port 74 communicates with the channel 660 instead of a fluid inlet and outlet. The vacuum port 74 is coupled to a vacuum device 76 that is operable to maintain the zone of negative pressure in the channel 660.

A negative pressure is established within the channel 660 and beneath the bottom surface 32 of the second galvanized steel workpiece 14 by activating the vacuum device 76 to evacuate air from the channel 660 through the vacuum port 74. The effect of this negatively pressurized zone is the same as before with respect to FIG. 2; that is, any zinc vapors that are created at the surfaces 18, 20, 28, 32 of the workpieces 12, 14 are drawn into the keyhole 56 and, ultimately, out of the bottom surface 32 of the second galvanized steel workpiece 14 through the keyhole 56, which penetrates entirely through the second galvanized steel workpiece 14. The zinc vapors are then removed from the channel 660 and carried away through the vacuum port 74. Providing such an avenue of escape for the zinc vapors, like before, allows the first and second galvanized steel workpieces 12, 14 to be laser welded together along their zero-gap faying interface 22 without accumulating an unacceptable amount of discrepancies in the weld joint 44.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding a workpiece stack-up that includes two or three overlapping metal workpieces, the method comprising:
providing a workpiece stack-up that includes at least a first metal workpiece and a second metal workpiece, the first metal workpiece having a top surface and the second metal workpiece having a bottom surface, wherein every workpiece faying interface in the workpiece stack-up between the top surface and the bottom surface is a zero-gap interface at a laser weld site, and wherein the workpiece stack-up includes a material at the laser weld site that is vaporazible during laser welding;
directing a laser beam at the top surface of the first metal workpiece and moving the laser beam along a weld path at the weld site, the laser beam impinging the top surface of the first metal workpiece and forming a keyhole that entirely penetrates the workpiece stack-up so as to reach the bottom surface of the second metal workpiece; and
extracting vapors, which are produced by heating the material that is vaporizable at laser welding temperatures, from the bottom surface of the second metal workpiece through the keyhole by establishing a zone of negative pressure underneath the bottom surface of the second metal workpiece at the weld site.

2. The method set forth in claim 1, wherein the first metal workpiece includes a faying surface and the second metal workpiece includes a faying surface, the faying surface of the first metal workpiece and the faying surface of the second metal workpiece overlapping and abutting to provide a zero-gap faying interface at the laser weld site.

3. The method set forth in claim 2, wherein a surface material that is vaporizable at laser welding temperatures is present on at least one of (1) the top surface of the first metal workpiece, (2) the faying surface of the first metal workpiece, (3) the faying surface of the second metal workpiece, or (4) the bottom surface of the second metal workpiece.

4. The method set forth in claim 3, wherein each of the first metal workpiece and the second metal workpiece is a galvanized steel workpiece.

5. The method set forth in claim 4, wherein the surface material is zinc, and the vapors that are extracted from the bottom of the second metal workpiece through the keyhole are zinc vapors.

6. The method set forth in claim 3, wherein each of the first metal workpiece and the second metal workpiece is an aluminum alloy workpiece, and wherein at least one of the first aluminum alloy workpiece or the second aluminum alloy workpiece includes a vaporizable material.

7. The method set forth in claim 3, wherein each of the first metal workpiece and the second metal workpiece is a copper or copper alloy workpiece, and wherein at least one of the first copper or copper alloy workpiece or the second copper or copper alloy workpiece includes a vaporizable material.

8. The method set forth in claim 1, wherein the laser beam originates from a remote laser welding apparatus and has a focal length of about 0.4 meters to about 1.5 meters.

9. The method set forth in claim 1, wherein a bottom workpiece holder contacts, and is pressed against, the bottom surface of the second metal workpiece, the bottom workpiece holder comprising a channel underneath the weld path tracked by the laser beam, and wherein the zone of negative pressure is established in the channel so that vapors produced by heating the surface material are extracted through the keyhole and into the channel.

10. The method set forth in claim 9, wherein the channel includes a fluid inlet and a fluid outlet, and wherein a fluid is passed through the channel from the fluid inlet to the fluid outlet at a velocity sufficient to create a negative pressure in the channel.

11. The method set forth in claim 10, wherein the fluid is an inert gas.

12. The method set forth in claim 9, wherein the channel includes a vacuum port, and wherein activation of a vacuum device coupled to the vacuum port operates to evacuate air from the channel to create a negative pressure in the channel.

13. The method set forth in claim 1, wherein each of the metal workpieces included in the workpiece stack-up are galvanized steel workpieces.

14. A method of laser welding a workpiece stack-up that includes two or three overlapping galvanized steel workpieces, the method comprising:
assembling a workpiece stack-up that includes two or three overlapping galvanized steel workpieces, the workpiece stack-up including at least a first galvanized steel workpiece, which includes a top surface, and a second galvanized steel workpiece, which includes a bottom surface, and wherein every workpiece faying surface between the top surface and the bottom surface is defined by a zero-gap surface-to-surface abutment;
directing a laser beam at the top surface of the first galvanized steel workpiece and moving the laser beam along a weld path, the laser beam impinging the top surface of the first galvanized steel workpiece and forming a keyhole that entirely penetrates the workpiece stack-up and reaches the bottom surface of the second galvanized steel workpiece; and
extracting zinc vapors produced by the laser beam from the bottom surface of the second galvanized steel workpiece through the keyhole by establishing a zone of negative pressure underneath the bottom surface of the second galvanized steel workpiece.

15. The method set forth in claim 14, wherein the laser beam originates from a remote laser welding apparatus and has a focal length of about 0.4 meters to about 1.5 meters.

16. The method set forth in claim 14, wherein a bottom workpiece holder contacts, and is pressed against, the bottom surface of the second galvanized steel workpiece, the bottom workpiece holder comprising a channel underneath the weld path tracked by the laser beam, and wherein the zone of negative pressure is established in the channel so that zinc vapors are extracted through the keyhole and into the channel.

17. The method set forth in claim 16, wherein the channel includes a fluid inlet and a fluid outlet, and wherein a fluid is passed through the channel from the fluid inlet to the fluid outlet at a velocity sufficient to create a negative pressure in the channel.

18. The method set forth in claim 17, wherein the fluid is an inert gas.

19. The method set forth in claim 16, wherein the channel includes a vacuum port, and wherein activation of a vacuum device coupled to the vacuum port operates to evacuate air from the channel to create a negative pressure in the channel.

20. The method set forth in claim 14, wherein a faying surface of the first galvanized steel workpiece and a faying surface of the second galvanized steel workpiece confront and abut to provide a single zero-gap faying interface within the workpiece stack-up.
